(19) United States
(12) Patent Application Publication
(10) Pub. No.: US 2006/0040099 A1
(43) Pub. Date: Feb. 23, 2006

(54) Sound-absorbing and soundproofing panel

(76) Inventor: Paolo Scudieri, Ottaviano (IT)

Correspondence Address: STETINA BRUNDA GARRED & BRUCKER, 75 ENTERPRISE, SUITE 250, ALISO VIEJO, CA, 92656, US

(21) Appl. No.: 10/528,741

(22) PCT Filed: Sep. 24, 2003
(86) PCT No.: PCT/EP03/10612

§ 371 Date: Mar. 22, 2005

(30) Foreign Application Priority Data
Sep. 24, 2002 (IT) RM2002A000472

(51) Int. Cl. B32B 3/00

(52) U.S. Cl. 428/316.6; 428/317.9

(57) ABSTRACT

A soundproofing and sound-absorbing panel consisting of two different layers: a first layer of plastic foam, and a second layer of material chosen from textile fibre mat, 100% PES, polyethylene foam, and similar. Said panel features excellent properties, specifically: the weight being equal, the panel dampens noise significantly better than other similar products; or, performance being equal, the panel is lighter than other similar products.

### TECHNICAL FIELD

This invention relates to a sound-absorbing and soundproofing panel. More particularly, it relates to a panel consisting of a first plastic foam layer coupled or not with a second layer of a different material; the panel has high sound-absorbing power, low impact strength, and good mechanical properties in general and is light, deformable, and able to spring back slowly to its original shape after the deforming action has ceased.

### BACKGROUND ART

In the area of sound-absorbing and/or soundproofing materials, several materials are known for some time now to filter and deaden sounds, utilised in specific ways depending on the particular field of application. Examples range from sophisticated and expensive engraved panels for anechoic chambers to simple plastic sheets coupled with high-damping sheets like sheet lead or high-density and low-impact strength plastic used, for example, to sound conditioning motor compartments of boats. In the automobile industry, examples of items used for sound conditioning include panels made of different fibres and/or plastic foam in combination with one layer of bitumen sheeting.

Besides varying significantly in performance (which may be very poor sometimes), the above materials have several drawbacks, such as excessive weight (for example, in the case of panels with sheet lead), voluminous size, high cost, or low mechanical strength (for example, the panels with a layer of bitumen sheeting which performance worsens over time and following exposure to low temperatures and/or temperature changes; furthermore, the panels can easily become dry, crack under the effect of the vibrations, and become detached from their support). Attempts put forward to improve the performance of said materials have not always produced the hoped for results. This is particularly true when limited dimensions and high absorptive power are required: the use of thin materials must be compensated for with high-density matter, increasing the weight, otherwise lower sound-insulating performance or limited mechanical properties must be accepted.

For example, U.S. Pat. No. 5,010,113 refers to a flame-retardant and soundproofing polyurethane material obtained by mixing and reacting together an amino-salt of phosphoric acid, a compound containing at least two reactive hydrogens, and a compound containing at least two isocyanate radicals.

The German patent application n. 1991 41229666 describes a sound-insulating viscoelastic foam, having an adhesive surface, obtained by making stoichiometric amounts of a polyisocyanate react with at least two polyols of the polyether type, which are incompatible with each other.

Patent no. EP0884349 describes a soundproofing material consisting of a cross-linked resin—chosen from the group comprising polyolefin, polystyrene, and polychlorovinyls—and an inert filler, preferably barium sulphate (referred to in the examples).

However, these documents do not make it clear what actual sound absorption coefficient is obtained, nor the effect of the inert filler other than to lower the cost of the finished product and to improve heat resistance.

### DESCRIPTION OF THE INVENTION

It is the object of this invention to provide a sound-insulating panel that is light, easy to mould, and very pliable and features a low impact strength, good mechanical strength, and high sound-absorbing and soundproofing performance; in addition, the panel should be able to maintain these properties over time, even in the presence of temperature changes.

The panel in accordance with present invention comprises a first layer, consisting of a viscoelastic plastic foam containing an inertly charged material that is uniformly dispersed, coupled with a second layer consisting of a material chosen from the group of textile fibre mat, 100% PES, and polyethylene foam. The textile fibre mat is of known type and essentially consists of spun yam waste of different types.

Said first layer of the panel preferably consists of a viscoelastic polyurethane foam made in compliance with state-of-the-art techniques by reacting together (i) at least one compound chosen from ethylene oxides and propylene oxides, the compound A, with (ii) an isocyanate compound, the compound B, in said polyurethane foam, being uniformly dispersed a micronized inert material, the compound C, chosen from fibreglass, artificial and natural textile fibres, silica, silicates, carbonates, and similar in combination or alone.

More specifically, the ethylene oxides and propylene oxides have a molecular weight falling within the range from 200 to 10,000, preferably from 200 to 6000, an hydroxyl number falling within the range from 20 to 1000, preferably from 20 to 800, and a functionality falling within the range from 3 to 8. These compounds are used alone (ethylene oxides or propylene oxides only) or are mixed together in accordance with known techniques. The isocyanate compound is chosen from the group comprising toluene diisocyanate, polymethylene-polyphenyl-isocyanates, and diphenylisocyanates with a molecular weight falling within the range from 200 to 8000, ideally from 200 to 6000.

Compounds A, B, and C are present in the reacting mixture in amounts expressed in percentages by weight, falling within the range from 30 to 75%, from 20 to 65%, and from 5 to 50%, respectively.

This first panel has a thickness falling within the range from 5 to 500 mm, and a specific weight falling within the range from 50 to 200 Kg/m³.

Preferably, the micronized material consists of fibreglass, silica, silicates, carbonates, and their mixtures with particle size falling within the range from 10 to 500 μm, preferably from 50 to 200 μm; anyhow, possible particle sizes fall within the range from 10 to 50 μm and from 10 to 30 μm.

Preferably, the material used to make said second layer is a felt, mat, or pressed material of natural or artificial textile fibres with a weight falling within the range from 400 to 1500 g/m² and a thickness falling within the range from 10 to 100 mm. The first and the second layer are coupled directly in the mould or by means of gluing. The preferred version of the final panel comprises a layer of viscoelastic polyurethane foam with a specific weight falling within the range from 85 to 120, preferably from 90 to 105 Kg/m³, and containing the micronized material in amounts expressed in percentages by weight falling within the range from 60 to 80%, preferably from 65 to 75%, the remaining being said second layer having a weight falling within the range from 400 to 900 g/m², preferably from 500 to 800 g/m².

In accordance with a preferred version of this invention, said first layer features a free or visible face with impressions having a broadly curvilinear shape (ideally circular, oval, or elliptical), a maximum transversal dimension falling within the range from 5 to 15 mm, preferably from 7 to 13 mm, a depth falling within the range from 1 to 10 mm, preferably from 2 to 6 mm and a distance between centres from 1.10 to 1.80 times said maximum transversal dimension.

The following examples show the technical results obtained by some panels according to present invention, given in an absolutely exemplification way, not limiting objects and scope of the invention itself.

### EXAMPLE 1

Panels were made consisting of a first layer of a polyurethane foam material obtained by reacting a mixture consisting of SPECFLEX NS 644 (made by DOW CHEMICAL), S.F. Ns 540 (made by DOW CHEMICAL), and textile fibre (polyester) in proportions of 40%, 50%, and 10%, respectively. The panels were made in three thicknesses (20, 30, and 45 mm) with a specific weight equal to 100 Kg/m³ and were coupled with a second layer consisting of a 20-mm thick mixed textile fibres mat with a weight of 1000 g/m². The obtained products underwent sound absorption tests in compliance with ASTM E1050-90 and ASTM C384-95. The results are summarized in Table 1 in terms of % of sound absorption.

TABLE 1

| | FREQUENCY (Hz) | | | | | |
|---|---|---|---|---|---|---|
| THICKNESS | 1000 | 2000 | 3000 | 4000 | 5000 | 6000 |
| 20 mm | 79 | 85 | 89 | 94 | 93 | 89 |
| 30 mm | 81 | 89 | 97 | 99 | 95 | 94 |
| 45 mm | 85 | 90 | 96 | 99 | 99 | 96 |

### EXAMPLE 2

A 20-mm thick first layer of material made as described in Example 1 was coupled to a second layer consisting of 100% PES; then, the resulting product underwent the sound absorption test referred to in the previous example. The panel was as it is and compressed as to reduce the thickness by 75%. The obtained results are shown in Table 2.

TABLE 2

| | FREQUENCY (Hz) | | | | | |
|---|---|---|---|---|---|---|
| PANEL | 1000 | 2000 | 3000 | 4000 | 5000 | 6000 |
| AS IT IS | 85 | 95 | 92 | 93 | 91 | 95 |
| COMPRESSED BY | 76 | 74 | 79 | 81 | 86 | 85 |
| 75% | | | | | | |

1. A multilayer soundproofing and sound-absorbing panel made of plastics coupled to a second suitable material, characterised in that it comprises a first layer consisting of a plastics foam containing an uniformly dispersed inert filler material and a second layer consisting of a material chosen from the group of textile fibre mat, 100% PES, and polyethylene foam.

2. A panel as claimed in claim 1 wherein said first layer consists of a viscoelastic polyurethane foam made in compliance with state-of-the-art techniques by reacting together (i) at least one compound chosen from ethylene oxides and propylene oxides, (compound A) with (ii) an isocyanate compound, (compound B), in said polyurethane foam being uniformly dispersed a micronized inert material chosen from fibreglass, calcium carbonate, artificial and natural textile fibres, silica, and similar in combination or alone, (compound C).

3. A panel as claimed in claim 2 wherein said ethylene and propylene oxides have a molecular weight falling within the range from 200 to 10,000, an hydroxyl number falling within the range from 20 to 1000, and functionality falling within the range from 2 to 8.

4. A panel as claimed in claim 3 wherein said ethylene and propylene oxides have a molecular weight falling within the range from 200 to 6000.

5. A panel as claimed in claim 3 wherein said ethylene and propylene oxides have a molecular weight falling within the range from 4000 to 6000.

6. A panel as claimed in claim 2 wherein said isocyanate compound is chosen from the group consisting of toluene diisocyanate, polymethylene-polyphenyl-isocyanates, and diphenylisocyanates.

7. A panel as claimed in claim 2 wherein said micronized material has a particle size falling within the range from 10 to 500 μm.

8. A panel as claimed in claim 7 wherein said particle size falls within the range from 50 to 200 μm.

9. A panel as claimed in claim 2 wherein said micronized material is present in said first layer in amounts expressed in percentages by weight falling within the range from 5 to 50.

10. A panel as claimed in claim 9 wherein said micronized material is present in said first layer in amounts expressed in percentages by weight falling within the range from 10 to 30.

11. A panel as claimed in claim 1 wherein said first layer features a free or visible face with impressions having a broadly curvilinear shape, ideally circular or oval or elliptical.

12. A panel as claimed in claim 11 wherein said impressions have a maximum transversal dimension falling within the range from 5 to 15 mm, a depth falling within the range from 2 to 6 mm, and a distance between centres from 1.10 to 1.80 times said maximum transversal dimension.
